(19) United States
(12) Patent Application Publication
(10) Pub. No.: US 2006/0072601 A1
(43) Pub. Date: Apr. 6, 2006

(54) Virtual IP interface

(76) Inventors: Zhidan Cheng, Sunnyvale, CA (US); Sandy Chang, San Jose, CA (US); Hua Chen, San Jose, CA (US); Jhaanaki Krishnan, San Jose, CA (US); Yalun Li, Fremont, CA (US)

Correspondence Address: LAW OFFICES OF MARK C. PICKERING, P.O. BOX 300, PETALUMA, CA, 94953, US

(21) Appl. No.: 10/662,703

(22) Filed: Sep. 15, 2003

(51) Int. Cl. H04L 12/56

(52) U.S. Cl. 370/419; 370/420

(57) ABSTRACT

The number of IP addresses required by a central office device, which is connected to a network segment and a number of customer internet devices to pass packets between the network segment and the customer internet devices, is reduced to one by using an IP address and a subnet mask that are associated with the network interface as a virtual interface. The subnet mask allows packets to be routed to the central office device, which then forwards the packets to the customer internet devices.

### BACKGROUND OF THE INVENTION

1. Field of the Invention.

The present invention relates to an internet protocol (IP) interface and, more particularly, to a virtual IP interface.

2. Description of the Related Art.

Internet Protocol (IP) addresses are assigned to IP interfaces which, in turn, are associated with the physical connections to a network segment. Thus, for example, a router, which has four ports that are physically connected to four network segments, has four corresponding IP interfaces associated with the four ports, and four IP addresses assigned to the four IP interfaces.

FIG. 1 shows a block diagram that illustrates a conventional central office device 100. As shown in FIG. 1, device 100 includes a bus 110, and a network line card 112 that is connected to bus 110 and to a network line 114 that provides access to an ATM switching network and the internet. Network line card 112 has an IP address that is associated with an IP interface which, in turn, is associated with the port that is connected to network line 114.

As further shown in FIG. 1, device 100 also includes a number of xDSL line cards 116 that are connected to bus 110. Each xDSL line card 116, in turn, has a number of local ports, such as 96, that are connectable to a number of customers, such as 96, via a number of local lines 118.

In addition, each local port has an associated IP interface which, in turn, has a corresponding IP address. Thus, when an xDSL line card 116 has 96 local ports, the xDSL line card 116 requires 96 IP interfaces and 96 IP addresses. Thus, when device 100 includes ten xDSL line cards 116, device 100 requires 960 IP addresses for the xDSL line cards 116.

As a result, one of the drawbacks of device 100 is that device 100 requires a large number of IP addresses. Due to the constraints of internet protocol version four (IPv4), only a limited number of IP addresses are available. Thus, there is a need for a central office device that consumes fewer IP addresses.

### SUMMARY OF THE INVENTION

The present invention provides a central office device that requires only a single IP address and a subnet mask, thereby eliminating the need to have separate IP interfaces and IP addresses for each of the local ports. A device in accordance with the present invention includes a bus, and a plurality of first line cards that are connected to the bus. Each first line card has a plurality of local ports, and each local port is connectable to a local segment that is connected to a customer device that has an IP address.

The device also includes a second line card that is connected to the bus. In addition, the second line card has a network port that is connectable to a network segment. The network port has an IP address and a subnet mask. The subnet mask includes a range that is sufficient to provide a predetermined number of IP addresses.

The present invention also includes a method of forwarding data packets from a central office device to a number of customers. The central office device has a bus, and a plurality of first line cards that are connected to the bus. Each first line card has a plurality of local ports where each local port is connectable to a local segment that is connected to a customer device that has a customer IP address.

The method includes the step of receiving messages that have a central office IP address and a subnet mask. The central office IP address and subnet mask have the customer IP address. The method also includes the steps of determining a first line card to receive a received message based on the customer IP address, and forwarding the received message to the first line card via the bus.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating a conventional central office device 100.

FIG. 2 is a block diagram illustrating an example of a central office device 200 in accordance with the present invention.

### DETAILED DESCRIPTION OF THE INVENTION

FIG. 2 shows a block diagram that illustrates an example of a central office device 200 in accordance with the present invention. As shown in FIG. 2, device 200 includes a bus 210, and a network line card 212 that is connected to both bus 210 and to a network line 214 that provides access to an ATM switching network and the internet.

Network line card 212 has an IP address that is associated with an IP interface which, in turn, is associated with the port that is connected to network line 214. In accordance with the present invention, the IP address has an associated subnet mask that identifies the IP addresses of all of the customer internet devices (hosts) that are connected to device 200.

Sub-netting, which is described in Request For Comments (RFC) 950, is a procedure for using a number of bits in the IP address to define a number of sub-networks within a network. With internet protocol version four (IPv4), each IP address has 32 bits where a first number of bits defines the network, and a second number of bits defines the hosts that are connected to the network.

With a class B address, the first 16 bits are used to identify the network, and the last 16 bits are used to define the hosts that are connected to the network. With sub-netting, the last 16 bits are further divided to define a number of sub-networks within the network, and a number of the hosts within each sub-network.

For example, the first 22 bits of the 16 host bits can be used to identify a number of sub-networks, while the last 10 bits of the 16 host bits can be used to identify 1022 customers within a sub-network. (RFC 950 prohibits host addresses that utilize all zeros or all ones. Thus, the total number of hosts that can be supported by a ten bit host address is 1022 or 1024-2.)

In addition to an IP address, a subnet mask is required to indicate the number of the 16 host bits that belong to the subnet address. A subnet mask can be expressed in dotted decimal notation such as 255.255.252.0, or in prefix length notation such as /22, which is equivalent to 255.255.252.0.

A subnet mask that uses a dotted decimal notation of 255.255.252.0 ([1111 1111] [1111 1111] [1111 1100] [0000 0000]) or a prefix length notation of /22 means that the first 22 bits of the 32 bit IP address are used for addressing (16 bits to define the network and 6 bits to define the sub-network), and 10 bits are used to identify one of 1022 potential hosts within the sub-network.

As further shown in FIG. 2, device 200 also includes a number of xDSL line cards 216. Each xDSL line card 216 has a port connected to bus 210, and a number of local ports, such as 96, that are connected to a number of local lines 218 which, in turn, are connected to a number of customer modems 220 at customer premises.

The xDSL modem 220 at a customer's premise, in turn, is connected to a number of customer internet devices, such as personal computers, and a telephone. Each customer internet device has a port that is physically connected to an xDSL modem 220, an IP interface that is associated with the port, and an IP address that is associated with the IP interface.

An IP address can be statically assigned to a customer internet device, or dynamically assigned when a customer wishes to access the internet. Since each xDSL modem 220 is connected to a known port on a known line card, an xDSL line card 216 is able to identify messages sent from a customer's xDSL modem 220. Each line card 212 and 216 maintains a table that indicates each of the IP addresses that are associated with each port of each line card 212 and 216.

In addition, the xDSL line cards 216 include DSL access modules (DSLAMs) that receive signals from a customer's xDSL modem 220, and separate the telephonic and data signals that are received from a customer's xDSL modem 220. The separated data signals are then forwarded to network line card 212. Similarly, the DSLAMs also combine telephonic and data signals that are then output to the customer's xDSL modem 220.

In operation, when a connection has been established and a customer wishes to output data to the internet, the xDSL modem 220 at the customer's premise outputs a message, which includes the IP address of the customer's internet device, to an xDSL line card 216 in the central office.

The xDSL line card 216 in the central office receives the message, requests control of bus 210, and transfers the message to network line card 212 via bus 210 after receiving control of bus 210. (One of the line cards can function as a bus master.) Network line card 212 receives the message, and forwards the message on to its destination.

In addition, network line card 212 advertises its IP address and subnet mask out to other routers. For example, assume that network line card 212 is connected to 10 xDSL line cards which, in turn, are each connected to 96 static IP addresses. In this example, network line card 212 needs to support 960 IP addresses. As a result, network line card 212 can utilize an IP address and a subnet mask of /22 to indicate that the last 10 bits of the host address are used to identify one of the 960 IP addresses.

Network line card 212 receives all of the messages that match the IP address and subnet mask of network line card 212, evaluates the IP addresses associated with the messages, and determines the line cards and ports that correspond with the IP addresses via the table. Following this, network line card 212 forwards the messages on to the xDSL line cards 216 on bus 210.

Each xDSL line card 216, in turn, receives the messages that match the IP addresses that are supported by the xDSL line card 216. When a message is received by an xDSL line card 216, the xDSL line card 216 forwards the message on to the local port that is associated with the IP address.

The xDSL line card 216 can forward the message to the local port based on forwarding information provided by network line card 212. Alternately, the xDSL line card 216 can forward the message to the local port by looking up the IP address associated with the message in the table in the xDSL line card 216.

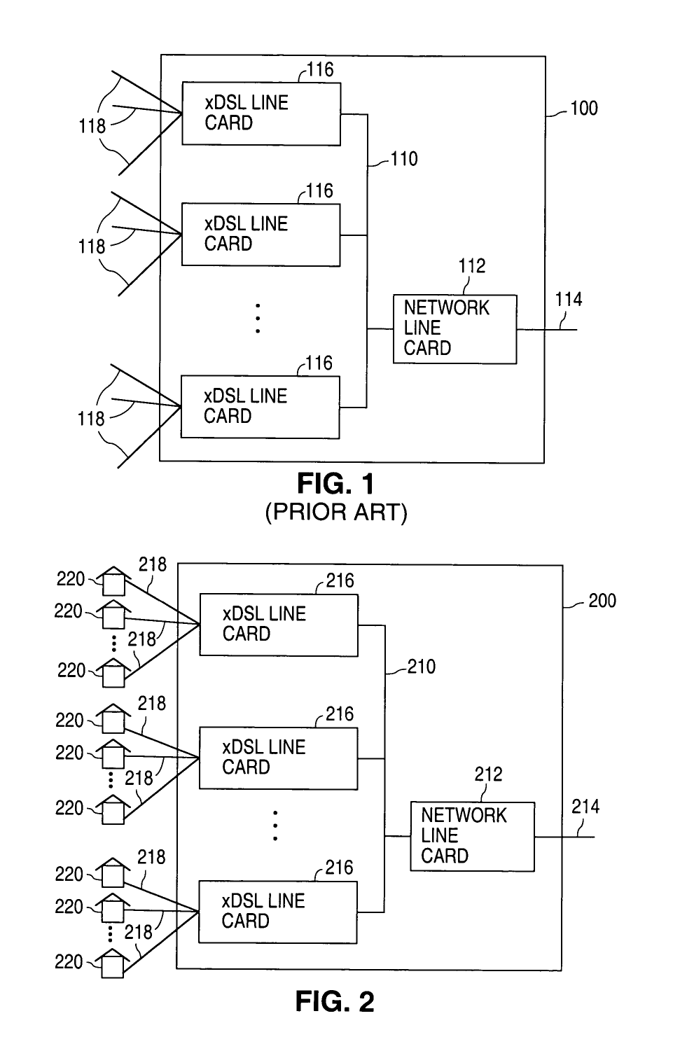

One of the advantages of the present invention is that device 200 eliminates the need for each of the xDSL line cards 216 in device 200 to have an IP address for each of its local ports. Thus, when compared to the FIG. 1 example of central office device 100 where ten xDSL line cards have a total of 960 ports with 960 IP interfaces and 960 IP addresses, central office device 200 requires 960 fewer IP interfaces and 960 fewer IP addresses.

In other words, rather than having 960 IP interfaces associated with 960 local ports which then require 960 IP addresses, and one IP interface and IP address associated with a network port, device 200 has one virtual IP interface associated with the network port that has one IP address and a subnet mask. The subnet mask, in turn, allows messages to be forwarded to the line cards 216 which, in turn, forward the messages on to the local port that is associated with the IP address of the message.

Another advantage of the present invention is that device 200 also supports a broadband RAS functionality. For example, a Point-to-Point Protocol (PPP) manager running on an xDSL line card 216 can detect an authentication request from a customer, such as a personal computer, collect log in information from the customer, such as the user name and password, and forward the request and log in information to a server executing the Remote Access Dial In User Service (RADIUS) client software.

The RADIUS protocol, which is described in Request for Comments (RFC) 2138, C. R. Livingston et al., April 1997, defines a procedure for sending authentication, authorization, and accounting information in a subscriber management system between a network access server executing RADIUS client software, and a remote authentication server executing RADIUS server software.

The server running the RADIUS client detects the authentication request, and constructs a RADIUS authentication request packet that includes the log in information. The RADIUS client also assigns a message identifier (MID) to the authentication request, and then sends the RADIUS authentication request packet to a remote RADIUS server.

The remote RADIUS server authenticates the user name and password, determines the level of service that the customer is authorized to receive, and then sends an authentication request accept packet, along with the configuration information that is needed to provide the service to the customer, back to the RADIUS client.

In response to the message from the remote RADIUS server, the RADIUS client sends the authentication results and the service to the PPP manager on the line card 216, which forwards the results to the requesting customer. Alternately, if the remote RADIUS server is unable to authenticate the user name and password, the remote RADIUS server returns an authentication request reject packet back to the RADIUS client.

It should be understood that the above descriptions are examples of the present invention, and that various alternatives of the invention described herein may be employed in practicing the invention. For example, the size of the subnet mask can be set to any value that provides enough IP addresses to cover the needs of the customer internet devices that are connected to central office device 200. Thus, it is intended that the following claims define the scope of the invention and that structures and methods within the scope of these claims and their equivalents be covered thereby.

What is claimed is:

1. A device comprising:
a bus;
a plurality of first line cards connected to the bus, each first line card having a plurality of local ports, each local port being connectable to a local segment that is connected to a customer device that has an IP address; and
a second line card connected to the bus, the second line card having a network port that is connectable to a network segment, the network port having an IP address and a subnet mask, the subnet mask including a range that is sufficient to provide a predetermined number of IP addresses.

2. The device of claim 1 wherein none of the local ports has an IP address.

3. The device of claim 2 wherein when the second line card receives messages from the network segment, the second line card forwards messages that match the IP address and subnet mask of the second line card to the first line cards.

4. The device of claim 3 wherein each line card maintains a table that indicates each of the IP addresses that are associated with each port of each line card.

5. The device of claim 4 wherein when a first line card is connected to a customer device with a device IP address, the first line card identifies messages on the bus that are directed to the device IP address, and forwards the messages to the local port that is associated with the device IP address.

6. The device of claim 4 wherein when a first line card is connected to a customer device with a device IP address, the first line card receives messages from the customer device, and forwards the messages to the second line card via the bus.

7. The device of claim 1 wherein the first line cards include xDSL line cards.

8. A method of forwarding data packets from a central office device to a number of customers, the central office device having:
a bus; and
a plurality of first line cards connected to the bus, each first line card having a plurality of local ports, each local port being connectable to a local segment that is connected to a customer device that has a customer IP address;
the method comprising the steps of:
receiving messages that have a central office IP address and a subnet mask, the central office IP address and subnet mask having the customer IP address;
determining a first line card to receive a received message based on the customer IP address; and
forwarding the received message to the first line card via the bus.

9. The method of claim 8 wherein the central office device includes a second line card connected to the bus, the second line card having a network port that is connectable to a network segment, the network port having the central office IP address and the subnet mask.

10. The method of claim 8 wherein none of the local ports has an IP address.

11. The method of claim 9 wherein each line card maintains a table that indicates each of the IP addresses that are associated with each port of each line card.

12. The method of claim 8 wherein when a first line card is connected to a customer device, the first line card identifies messages on the bus that are directed to the customer IP address, and forwards the messages to the local port that is associated with the customer IP address.
